(19) United States
(12) Patent Application Publication
(10) Pub. No.: US 2022/0198464 A1
(43) Pub. Date: Jun. 23, 2022

(54) METHODS FOR AUTOMATED PREDICTIVE MODELING TO ASSESS CUSTOMER CONFIDENCE AND DEVICES THEREOF

(71) Applicant: Orolia USA Inc., W. Henrietta, NY (US)

(72) Inventors: Justin M. Velez, Fairport, NY (US); Alaysia Gilbert, Albany, NY (US)

(21) Appl. No.: 17/127,784

(22) Filed: Dec. 18, 2020

(51) Int. Cl. G06Q 30/00; G06N 20/00; G06F 40/20; G06F 17/18

(52) U.S. Cl. CPC G06Q 30/016; G06F 17/18; G06F 40/20; G06N 20/00

(57) ABSTRACT

A method, non-transitory computer readable medium and device that assesses customer confidence includes retrieving at least customer service data and customer order data from one or more stored customer database systems associated with customer identifiers for a plurality of customers. A predictive modeling algorithm on the customer service data and the customer order data is executed to generate one of a plurality of customer confidence rankings for each of the customer identifiers. At least one action is initiated based on the generated customer confidence rankings for the one or more customer identifiers.

### FIELD

This technology generally relates to methods and devices for assessing customer confidence and more particularly, methods and devices for enabling automated predictive modeling to assess customer confidence over a given time period and initiate action.

### BACKGROUND

Maintaining and growing business from existing customer relationships is essential for the ongoing success of companies. Unfortunately, identifying when any of these currently pending customer relationships may require action to avoid a potential reduction or loss of future sales is particularly challenging.

Prior techniques have attempted to address this issue retroactively, such as with customer surveys and other feedback mechanisms. These prior techniques can be valuable, but in many situations that feedback and any resulting corrective action may be too late to avoid a reduction or loss of future sales and customer relationships. Further, compounding the difficulties in applying any type of analytics to identify these customer issues are challenges with accurately identifying and compiling relevant data to conduct any analytics and effectively identifying the necessary correlations for any customer analytics.

### SUMMARY

A method for assessing of customer confidence includes retrieving, by a computing device, at least customer service data and customer order data from one or more stored customer database systems associated with customer identifiers for a plurality of customers. A predictive modeling algorithm on the customer service data and the customer order data is executed, by the computing device, to generate one of a plurality of customer confidence rankings for each of the customer identifiers. At least one action is initiated, by the computing device, based on the generated customer confidence rankings for the one or more customer identifiers.

A customer confidence management computing device comprising memory comprising programmed instructions stored thereon and one or more processors configured to be capable of executing the stored programmed instructions to retrieve at least customer service data and customer order data from one or more stored customer database systems associated with customer identifiers for a plurality of customers. A predictive modeling algorithm on the customer service data and the customer order data is executed to generate one of a plurality of customer confidence rankings for each of the customer identifiers. At least one action is initiated based on the generated customer confidence rankings for the one or more customer identifiers.

A non-transitory computer readable medium having stored thereon instructions comprising executable code which when executed by one or more processors, causes the one or more processors to retrieve at least customer service data and customer order data from one or more stored customer database systems associated with customer identifiers for a plurality of customers. A predictive modeling algorithm on the customer service data and the customer order data is executed to generate one of a plurality of customer confidence rankings for each of the customer identifiers. At least one action is initiated based on the generated customer confidence rankings for the one or more customer identifiers.

This technology provides a number of advantages including providing methods, non-transitory computer readable media and devices for enabling automated predictive modeling to assess customer confidence of a customer base within a given time period and initiate action. In particular, examples of this technology enable a modeled prediction of the chances of any single customer within an active customer base having an issue with products that they have received, are already scheduled to receive or that they are expected to purchase. Additionally, examples of this technology enable a comparison of customers in a customer base against each other based off customer confidence predictions to generate a ranked list of who should receive immediate attention from a client representative and in what order of priority and initiate one or more actions. Further, examples of this technology utilize a predictive model that uniquely correlates customer service data and customer order data to accurately identify an incident risk level associated with existing customers in a customer base. As a result, this technology provides an automated analytic approach that enables an entity to get ahead of issues a customer might encounter based on the automated analysis of past experiences to prevent repeat or similar problems from occurring.

### BRIEF DESCRIPTION OF THE DRAWINGS

FIG. 1 is a block diagram of an exemplary sales environment with an exemplary customer confidence management computing device;

FIG. 2 is a block diagram of one of the exemplary customer confidence management computing device of FIG. 1;

FIG. 3 is a flowchart of an exemplary method for automated predictive modeling to assess customer confidence;

FIG. 4 is a functional block diagram of the exemplary method shown in FIG. 3;

FIG. 5 is a diagram illustrating an example of a binomial probability cumulative distribution function for automated predictive modeling to assess customer confidence.

### DETAILED DESCRIPTION

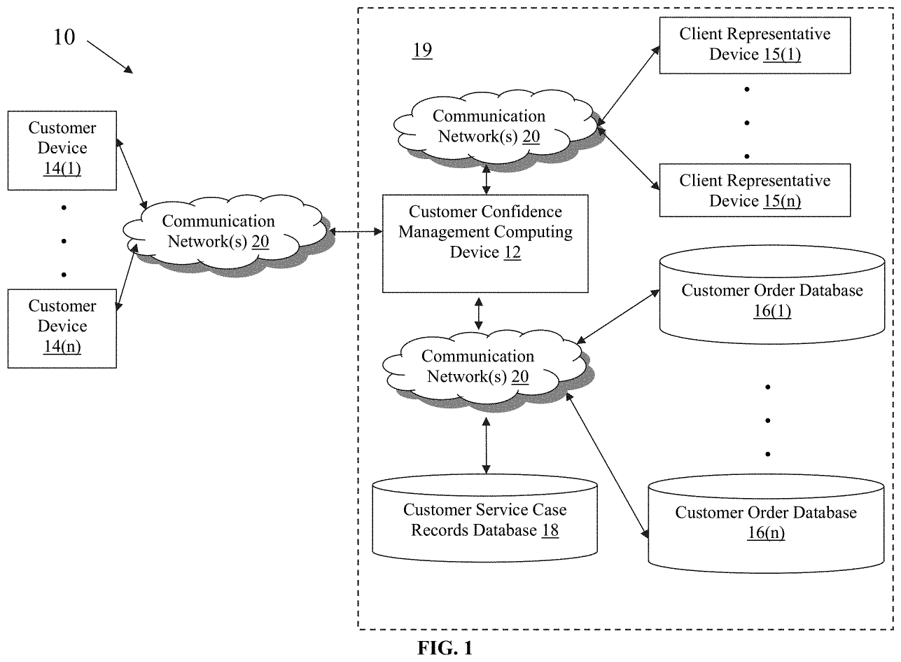

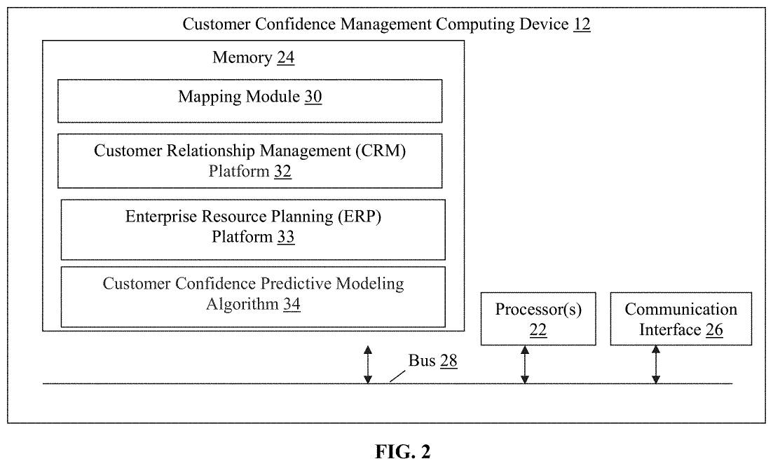

An exemplary sales environment 10 with an example of a customer confidence management computing device 12 that enables automated predictive modeling to assess customer confidence over a given time period and initiate action is shown in FIGS. 1-2. In this particular example, an entity 19 that is managing customer relations with a plurality of customer client devices 14(1)-14(n) for a plurality of different customers via one or more communication network(s) 20 comprises the customer confidence management computing device 12, client representative devices 15(1)-15(n) for the entity 19, a plurality of customer order databases 16(1)-16(n), and a customer service case records database 18, although the entity may comprise other types and/or numbers of other devices, systems and/or elements coupled together via other topologies. This technology provides a number of advantages including providing methods, non-transitory computer readable media, and customer confidence management computing devices that enable automated predictive modeling to assess customer confidence of a customer base within a given time period and initiate action.

Referring to FIGS. 1-2, the customer confidence management computing device 12 may perform any number of functions and other operations to manage customer relationships with one or more of the customer computing devices 14(1)-14(n) by way of the examples illustrated and described herein. In this example, the customer confidence management computing device 12 includes one or more processor(s) 22, a memory 24, and/or a communication interface 26, which are coupled together by a bus or other communication link 2628 although the customer confidence management computing device 12 can include other types and/or numbers of elements in other configurations, although this technology may for example be incorporated as programmed instructions within one or more computing devices at the entity 19.

The processor(s) 22 of the customer confidence management computing device 12 may execute programmed instructions stored in the memory of the customer confidence management computing device 12 for the any number of the functions identified above. The processor(s) 22 of the customer confidence management computing device 12 may include one or more CPUs or general purpose processors with one or more processing cores, for example, although other types of processor(s) can also be used.

The memory 24 of the customer confidence management computing device 12 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory 24.

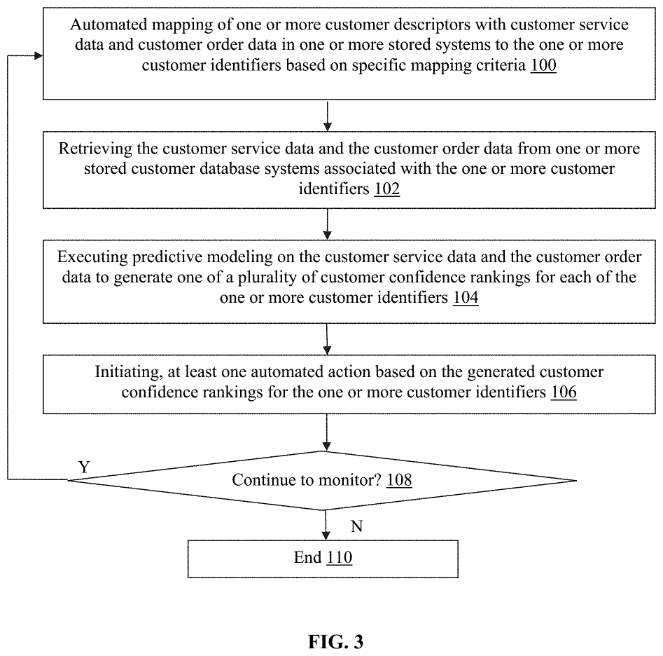

Accordingly, the memory 24 of the customer confidence management computing device 12 can store one or more applications that can include computer executable instructions that, when executed by the customer confidence management computing device 12, cause the customer confidence management computing device 12 to perform actions, such as to transmit, receive, or otherwise process messages or other requests, perform customer analytics and modeling, and other actions as described and illustrated in the examples below with reference to FIGS. 3-5. The application(s) can be implemented as modules, programmed instructions or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the customer confidence management computing device 12 itself, may be located in virtual server(s) running in a cloud-based computing environment rather than being tied to one or more specific physical network computing devices. Also, the application(s) may be running in one or more virtual machines (VMs) executing on the customer confidence management computing device 12. Additionally, in one or more embodiments of this technology, virtual machine(s) running on the customer confidence management computing device 12 may be managed or supervised by a hypervisor.

In this particular example, the memory 24 of the customer confidence management computing device 12 includes a mapping module 30, a Customer Relationship Management (CRM) platform 32, an Enterprise Resource Planning (ERP) platform 33, and a customer confidence predictive modeling algorithm 34, although the memory 24 can for example include other types and/or numbers of modules, platforms, algorithms, programmed instructions, applications, or databases for implementing examples of this technology.

In this example, the mapping module 30 may comprise programmed instructions and rules or other criteria which enable identification and association of relevant data, such as customer service case record data, customer order data, and customer opportunity pre-sales data identified and associated with customer identifiers by way of example only, which may be stored in various ways, although other types of data mapping instructions and/or criteria may be used. The CRM platform 32 may comprise programmed instructions for a sales management platform for assisting with customer marketing, sales, commerce, and/or service, although other types of customer management applications may be used. The ERP platform 33 may comprise programmed instructions for predicting delivery dates, order fulfillment details, invoicing data, export details and other relevant customer management information, although other types of applications may be used. The customer confidence predictive modeling algorithm 34 may comprise programmed instructions for a binomial probability cumulative distribution function to assess customer confidence, such as the one illustrated and described in FIG. 5, although other types of predictive modeling, algorithms or other applications may be used. Examples of each of the mapping module 30, the CRM platform 32, the ERP platform 33 and the customer confidence predictive modeling algorithm 34 are illustrated and described in greater detail by way of the examples herein.

The communication interface 26 of the customer confidence management computing device 12 operatively couples and communicates between the customer confidence management computing device 12, the customer devices 14(1)-14(n), the client representative devices 15(1)-15(n), and/or the customer order databases 16(1)-16(n) and customer service case records database 18, which are all coupled together by the communication network(s) 20, although other types and/or numbers of communication networks or systems with other types and/or numbers of connections and/or configurations to other devices and/or elements can also be used.

By way of example only, the communication network(s) 20 can include local area network(s) (LAN(s)) or wide area network(s) (WAN(s)), and can use TCP/IP over Ethernet and industry-standard protocols, although other types and/or numbers of protocols and/or communication networks can be used. The communication network(s) 20 in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. The communication network(s) 20 can also include direct connection(s) between one or more of the customer confidence management computing device 12, one or more of the customer devices 14(1)-14(n), one or more of the client representative devices 15(1)-15(n), or one or more of the customer order databases devices 16(1)-16(n) or customer service case records database 18.

While the customer confidence management computing device 12 is illustrated in this example as including a single device, the customer confidence management computing device 12 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the customer confidence management computing device 12.

Additionally, one or more of the devices that together comprise the customer confidence management computing device 12 in other examples can be standalone devices or integrated with one or more other devices or apparatuses, such as in one of the server devices or in one or more computing devices at the entity19 which is managing customer sales, for example. Moreover, one or more of the devices of the customer confidence management computing device 12 in these examples can be in a same or a different communication network including one or more public, private, or cloud networks, for example.

The customer devices 14(1)-14(n) in this example are at or associated with a plurality of different exemplary customers of the entity 19 and may include any type of computing device that can facilitate user interaction with the entity 19, such as mobile computing devices, desktop computing devices, laptop computing devices, tablet computing devices, virtual machines (including cloud-based computers), or the like. Each of the customer devices 14(1)-14(n) in this example may include a processor, a memory, and a communication interface, which are coupled together by a bus or other communication link, although other numbers and/or types of network devices could be used.

The customer devices 14(1)-14(n) may run interface applications, such as standard Web browsers or standalone client applications, which may provide an interface to make requests for, and interact with the customer confidence management computing device 12 for systems, applications, products, or other services via the communication network(s) 20. The customer devices 14(1)-14(n) may further include a display device, such as a display screen or touchscreen, and/or an input device, such as a keyboard for example.

The client representative devices 15(1)-15(n) of the entity 19 in this example may include any type of computing device that can facilitate client representative interaction with any of the customer devices 14(1)-14(n) at any of the customers, such as mobile computing devices, desktop computing devices, laptop computing devices, tablet computing devices, virtual machines (including cloud-based computers), or the like. Each of the client representative devices 15(1)-15(n) in this example includes a processor, a memory, and a communication interface, which are coupled together by a bus or other communication link, although other numbers and/or types of network devices could be used.

The client representative devices 15(1)-15(n) may run interface applications, such as standard Web browsers or standalone client applications, which may provide an interface to make requests for, and interact with the customer confidence management computing device 12 and with one or more of the customer devices 14(1)-14(n) at the plurality of customers regarding the entity's offered systems, applications, products, or other services via the communication network(s) 20. The client representative devices 15(1)-15(n) may further include a display device, such as a display screen or touchscreen, and/or an input device, such as a keyboard for example.

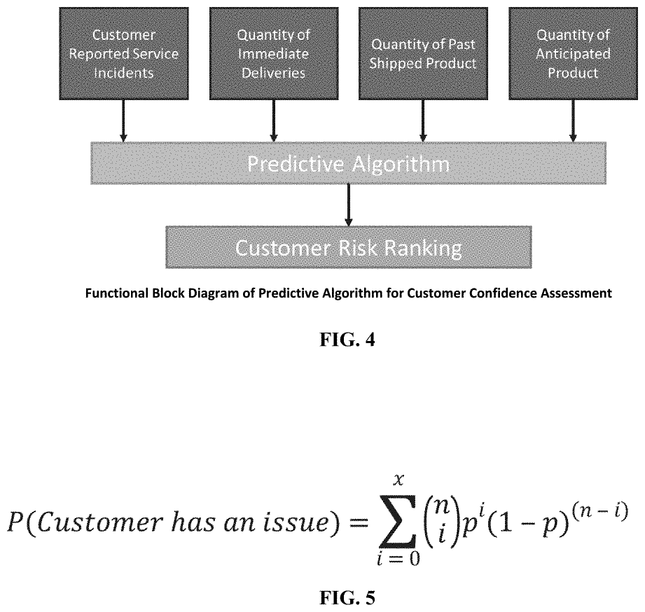

In this example, the customer order database devices 16(1)-16(n) may comprise one or more databases which store in-process sales order data, in-preparation sales order data, open sales order data, and pre-sales opportunity data with various customer descriptors that may be associated with a customer identifier for a plurality of customers at the customer devices 14(1)-14(n), although other types of data may be stored and this customer order data may be stored in other manners and locations, such as in memory 24 by way of example only. The customer service case records database 18 may store customer service data for a plurality of customers, such as customer service case records about any type of service or other issue associated with customer identifiers of any of the customers at the customer devices 14(1)-14(n), with any of the customer order data, although other types of data may be stored and this customer service data may be stored in other manners and locations, such as in memory 24 by way of example only. In another example shown in FIG. 4, quantity of immediate deliveries, quantity of past shipped product and quantity of anticipated product is stored as customer sales order data in one or more of the customer order databases 16(1)-16(n) and customer reported service incidents are stored as customer service data in customer service case records database 18. Each of the customer order database devices 16(1)-16(n) and the customer service case records database 18 are illustrated and described in greater detail by way of the examples herein.

Although the exemplary customer confidence management computing device 12, customer devices 14(1)-14(n), client representative devices 15(1)-15(n), customer order databases 16(1)-16(n), customer service case records database 18 and communication network(s) 20 are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in this environment 10, such as the customer confidence management computing device 12, customer devices 14(1)-14(n), client representative devices 15(1)-15(n), customer order databases 16(1)-16(n), and customer service case records database 18, for example, may be configured to operate as virtual instances on the same physical machine. In other words, by way of example one or more of the customer confidence management computing device 12, client representative devices 15(1)-15(n), customer order databases 16(1)-16(n), and customer service case records database 18 may operate on the same physical device rather than as separate devices communicating through communication network(s). Additionally, there may be more or fewer customer confidence management computing device 12, customer devices 14(1)-14(n), client representative devices 15(1)-15(n), customer order databases 16(1)-16(n), and customer service case records database 18 than illustrated in FIG. 1. The customer devices could also be implemented as applications on a computing device at the entity 19 as a further example.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

An exemplary method that enables automated predictive modeling to assess customer confidence of a plurality of customers in a customer base within a given time period and initiate an action will now be described with reference to FIGS. 1-5. Referring more specifically to FIGS. 3-4, in this example in step 100 the customer confidence management computing device 12 executes an automated mapping of each of one or more customer descriptors stored with customer service data and customer order data in one or more stored systems for entity 19 to one or more customer identifiers for customers at the customer devices 14(1)-14(n) based on specific mapping criteria. By way of example only, the one or more customer descriptors stored with customer service data and customer order data may comprise customer descriptors stored with customer service case records about any type of service or other issue associated with customer identifiers of any of the customers at the customer devices 14(1)-14(n) in customer service case records database 18 and/or customer descriptors stored with in-process sales order data, in-preparation sales order data, open sales order data, and/or pre-sales opportunity data associated with customer identifiers of any of the customers at the customer devices 14(1)-14(n) in customer order database 16(1)-16(n) by way of example. Additionally, in this example the specific mapping criteria comprises a matching algorithm executed by the customer confidence management computing device 12 that matches various ways a customer account or other customer descriptor are associated with each of the customer identifiers for customers at the customer devices 14(1)-14(n) through stored tables or columns of matching data and/or other character matching rules, although other types of criteria may be used. Further in this example the customer confidence management computing device 12 may search for this customer order data and customer service data over a given or other set time period or window, such as over the last twelve months by way of example only. The time period or window will add and/or eliminate portions of the customer order data and/or the customer service data as adjusted or as the window for the set time period is, for example, slid forward in time which may alter the resulting predictive modeling and generated customer confidence rankings. In this example the customer confidence management computing device 12 may also apply one or more filters to the customer order data and/or the customer service data. For example, the customer confidence management computing device 12 may apply a filter that determines a percentage of the pre-sales opportunities in the pre-sales opportunity data to use in the customer order data in the predictive modelling algorithm. In another example, the customer confidence management computing device 12 may apply another filter that eliminate data on any recorded issues associated with customer identifiers for customers which may have input data indicating a successful resolution. In another example, the customer confidence management computing device 12 may apply another filter that applies one of a plurality of severity levels with respect to any identified issues in the customer service data which can be utilized by the predictive modeling algorithm when generating customer confidence rankings, although other types and/or numbers of filters can be used and in other examples machine learning can be used to identify preferred control parameters for this analysis as described herein.

In step 102, the customer confidence management computing device 12 may, for a given or set time period, retrieve relevant portions of the customer service data comprising datasets of customer service case records associated with customer identifiers for the plurality customers and the customer order data comprising in-process sales order data, in-preparation sales order data, open sales order data, and/or pre-sales opportunity data associated with the one or more customer identifiers for the plurality of customers from one or more stored customer database systems, such as customer order databases 16(1)-16(n) and customer service case records database 18 by way of example.

In step 104, the customer confidence management computing device 12 may execute a predictive modeling algorithm on the customer service data and the customer order data to generate one of a plurality of customer confidence rankings for each of the customer identifiers for the customers at the customer devices 14(1)-14(n). By way of example only a functional block diagram of this process is illustrated in FIG. 4 along with an example in a FIG. 5 of a binomial probability cumulative distribution function for an example of a predictive modeling algorithm used to generate a customer confidence ranking for each of the customer identifiers for the customers.

Referring more specifically to FIG. 5, this example of a binomial probability cumulative distribution function is executed as the predictive modeling algorithm by the customer confidence management computing device 12. In this illustrated example, this binomial probability cumulative distribution function is used by the customer confidence management computing device 12 to rank customer risk customers at customer devices 14(1)-14(n) by evaluating their established case rate, referred to herein as the customer service data, to their planned shipments, referred to herein as the customer sales data or at least a portion of the customer order data. This function determines the probability that up to “x” number of cases will be created after the customer at one of the customer devices 14(1)-14(n) receives their planned orders.

In particular for this example of the probability cumulative distribution function shown in FIG. 5:

n=sum of the quantities in the ERP database of sales orders that have an item status of “in process”, “in preparation”, and “open”, as well as the CRM database opportunity item quantity with a win probability greater than or equal to 60% which comprises the customer order data, although other types and/or combinations of sales order data may be used. The 60% threshold is variable, to accommodate preferences of the company's responsiveness and is shown for example only.

x=cases opened for the customer (number of issues seen) which comprises the customer service data.

$$( \begin{matrix}n \\ i\end{matrix} ) .$$

is the binomial coefficient representing the number of ways “i” number of cases could be created out of “n” items sold.

p=rate which a customer has opened a case in the time evaluated which is data stored in the customer service case records database 18 and may be retrieved as part of the customer service data as described in the examples earlier. p=total cases opened/total quantity of orders completed. Should p≥1, the customer confidence predictive modeling algorithm 34 will rank the customer using this value instead of the calculated binomial probability cumulative distribution function shown in FIG. 5.

As illustrated in this example, the execution of the predictive modeling algorithm on this unique correlation of different parts of or all of the customer service data as well as the customer order data by the customer confidence management computing device 12 enables a generation of a customer confidence ranking for each of the customers based on their predicted likelihood of encountering a problem or question concerning products or other services the customers have received, are anticipating purchasing or are already awaiting delivery. This allows the entity 19 to automatically identify and focus in and/or direct an automated action on the immediate one or more of the customers at the customer devices 14(1)-14(n) who are identified as having the highest generated risk ranking or above a set threshold for having a poor experience with or without the customer(s) at the customer devices 14(1)-14(n) actually notifying the entity 19 of any issue.

As illustrated in these examples, the customer confidence management computing device 12 uses a predictive modeling algorithm (also referred to as a customer confidence predictive algorithm) to do a comparative analysis of customer service data and customer order data to predictive future occurrence probability. Execution of the algorithm enables a generation of a prediction of what customers will have problems through a ranked risk-list. In this particular example, the lower the ranking (1) means that customer is at the greatest risk of having an issue or poor experience during the next 30 days. Additionally, in this example the higher the number the less of a concern of the customer running into an issue. Ultimately, the execution of this predictive modeling algorithm by the customer confidence management computing device 12 over a given or set time period provides a continually refocused list of generated risk for customers who may have experienced customer service issues represented by the customer service data that indicates a possible poor experience and generated prediction of possible lost existing and futures sales with or without the customers at the customer devices 14(1)-14(n) providing any explicit notice.

In step 106, the customer confidence management computing device 12 may initiate at least one action, such as one of a plurality of stored automated actions, based on the generated customer confidence rankings for the one or more customer identifiers associated with customers at the customer devices 14(1)-14(n), although this action may in other examples be provided in a display or other communication mechanism to provide the necessary information for a manual action to be initiated. By way of example, the customer confidence management computing device 12 may transmit a notification to one or more of the client representative devices 15(1)-15(n) associated with the one or more of the customers at the customer devices 14(1)-14(n) with the highest generated risk(s) or a generated risk(s) above a set threshold to initiate an action, such as generation of a client communication or automated calendar entry for a client follow up by way of example, although other types of actions may be initiated. For example, the automated action may be an automated direct communication to the one or more identified customers at the customer devices 14(1)-14(n) with the highest generated risk, an automated adjustment with respect to paid, outstanding to future costs, or an automated action to address any specifically identified outstanding issue(s) in the stored service data, such as initiation of a particular service or services to address any outstanding issue(s), by way of example. Accordingly, as illustrated by this example, the claimed technology enables an entity an automated method based on a unique correlation of customer service data and customer order data over a given or set time period to get ahead of and identify any hidden or unrecognized issues with any customer to minimize or avoid any lost current or future sales.

In step 108, the customer confidence management computing device 12 may determine whether to continue to monitor the customers at the customer devices 14(1)-14(n). As noted in the examples above, typically this technology will continue to be executed with a sliding time period or window to enable the entity 19 to stay on top of all customer issues. If in step 108 the customer confidence management computing device 12 determines that monitoring should continue, then the Yes branch may be taken back to step 100 as described earlier. If in step 108 the customer confidence management computing device 12 determines that monitoring should not continue, then the No branch may be taken to step 110 where this example of the method may end.

In another example of this technology, the customer confidence management computing device 12 may also utilize machine learning to further optimize the predictive modeling algorithm to assess customer confidence of a customer base within a given time period and initiate action. In particular in this example, control parameters on training the predictive modeling algorithm may be optimized via Machine Learning (ML) techniques. In this example, the three main observables—n=customer orders, x, =open cases, and p=case rate—are used as training data for the predictive modeling algorithm. The predictive modeling algorithm is run at various levels for the control parameters and the automated assessment of customer confidence for customers in an entity's customer base is executed. After a period of time, the determined predictions by the execution of machine learning are compared to input data on actual customer confidence measurements made after the fact. The control parameters values which yielded the best match of prediction to actual customer confidence measurements are chosen and used to refine the predictive modelling algorithm. By way of example, data for the actual customer confidence measurements can be obtained through the use of an industry standard Net Promoter Score (NPS) where customers are surveyed to determine if they would favorably or unfavorably promote our company to their colleagues and this data is collected and input into the executed calculations.

In this example, the one or more control parameters executed in a machine learning technique on the predictive modeling algorithm to optimize the generation of one of the plurality of customer confidence rankings for each of the customer identifiers may include: a confidence interval time period over which an evaluation is executed; a warranty return rate of each specific customer rather than the general population; a win probability to classify a pre-sales opportunity as part of the n orders in process; one or more adjustments to what is summed into n for the in-process sales order data, the in-preparation sales order data, the open sales order data, or the pre-sales opportunity data for the customer identifiers; warranty data on a number of warranty returns; natural language processing and assessment of customer textual input in one of a plurality of assessment categories, such as favorable, unfavorable, or neutral; or prior issue data on any repeated issue previously documented as known by any of the customer identifiers, by way of example only.

Accordingly, as illustrated and described by way of the examples herein this technology enables automated predictive modeling to assess customer confidence of a customer base within a given time period and to initiate action. In particular, examples of this technology enable a modeled prediction of the chances of any single customer within an active customer base having an issue with products that they have received, are already scheduled to receive, or that they are expected to purchase. Additionally, examples of this technology enable a comparison of a customers in a customer base against each other based off customer confidence predictions to generate a ranked list of who should receive immediate attention from a client representative and in what order of priority. Further, examples of this technology utilize a predictive model that uniquely correlates customer service data and customer order data to accurately identify an incident risk level associated with existing customers in a customer base. As a result, this technology provides an automated approach that enables an entity to get ahead of issues a customer might encounter based on past experiences to prevent repeat or similar problems from occurring.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for assessing of customer confidence, the method comprising:
retrieving, by a computing device, at least customer service data and customer order data from one or more stored customer database systems associated with customer identifiers for a plurality of customers;
executing, by the computing device, a predictive modeling algorithm on the customer service data and the customer order data to generate one of a plurality of customer confidence rankings for each of the customer identifiers; and
initiating, by the computing device, at least one automated or manual action based on the generated customer confidence rankings for the one or more customer identifiers.

2. The method as set forth in claim 1 further comprising automated mapping, by the computing device, of one or more customer descriptors with the customer service data and the customer order data in one or more stored systems to the one or more customer identifiers based on specific mapping criteria, wherein the retrieving is further based on the automated mapping.

3. The method as set forth in claim 1 wherein the customer service data comprises datasets of customer service case records for the customer identifiers and wherein the customer order data comprises in-process sales order data, in-preparation sales order data, open sales order data, and pre-sales opportunity data for the plurality of customers.

4. The method as set in claim 3 wherein the pre-sales opportunity quantities data in the customer order data comprises a determined percentage of successfully completing each of the pre-sales opportunity sales in the pre-sales opportunity data.

5. The method as set forth in claim 3 wherein the executing the predictive modeling further comprises:
executing, by the computing device, a binomial distribution algorithm on the customer service case records and the customer order data.

6. The method as set forth in claim 1 wherein the executing the predictive modeling algorithm on the customer service data and the customer order data is over a set period of time, wherein the set period of time is adjustable.

7. The method as set forth in claim 1 further comprising:
executing, by the computing device, a machine learning technique on the predictive modeling algorithm based on one or more control parameters to optimize the generation of one of the plurality of customer confidence rankings for each of the customer identifiers;
wherein the one or more control parameters comprise: a confidence interval time period over which an evaluation is executed; a warranty return rate of each of the customer identifiers; a win probability to classify a pre-sales opportunity as part of the n orders in process; one or more adjustments to what is summed into n for the in-process sales order data, the in-preparation sales order data, the open sales order data, or the pre-sales opportunity data for the customer identifiers; warranty data on a number of warranty returns; natural language processing and assessment of customer textual input in one of a plurality of assessment categories; or prior issue data on any repeated issue previously documented as known by any of the customer identifiers.

8. A customer confidence management computing device, comprising memory comprising programmed instructions stored thereon and one or more processors configured to be capable of executing the stored programmed instructions to:
retrieve at least customer service data and customer order data from one or more stored customer database systems associated with customer identifiers for a plurality of customers;
execute predictive modeling algorithm on the customer service data and the customer order data to generate one of a plurality of customer confidence rankings for each of the customer identifiers; and
initiate at least one automated action based on the generated customer confidence rankings for the one or more customer identifiers.

9. The device as set forth in claim 8 wherein the one or more processors are further configured to be capable of executing the stored programmed instructions to:
automated map of one or more customer descriptors with the customer service data and the customer order data in one or more stored systems to the one or more customer identifiers based on specific mapping criteria, wherein the retrieving is further based on the automated mapping.

10. The device as set forth in claim 8 wherein the customer service data comprises datasets of customer service case records for the customer identifiers and wherein the customer order data comprises in-process sales order data, in-preparation sales order data, open sales order data, and pre-sales opportunity data for the plurality of customers.

11. The device as set in claim 10 wherein the pre-sales opportunity quantities data in the customer order data comprises a determined percentage of successfully completing each of the pre-sales opportunity sales in the pre-sales opportunity data.

12. The device as set forth in claim 10 wherein for the execute the predictive modeling, the one or more processors are further configured to be capable of executing the stored programmed instructions to:
execute a binomial distribution algorithm on the customer service records and the customer order data.

13. The device as set forth in claim 8 wherein for the execute the predictive modeling algorithm on the customer service data and the customer order data is over a set period of time, wherein the set period of time is adjustable.

14. The device as set forth in claim 8 wherein the one or more processors are further configured to be capable of executing the stored programmed instructions to:
execute a machine learning technique on the predictive modeling algorithm based on one or more control parameters to optimize the generation of one of the plurality of customer confidence rankings for each of the customer identifiers;
wherein the one or more control parameters comprise: a confidence interval time period over which an evaluation is executed; a warranty return rate o of the customer identifiers; a win probability to classify a pre-sales opportunity as part of the n orders in process; one or more adjustments to what is summed into n for the in-process sales order data, the in-preparation sales order data, the open sales order data, or the pre-sales opportunity data for the customer identifiers; warranty data on a number of warranty returns; natural language processing and assessment of customer textual input in one of a plurality of assessment categories; or prior issue data on any repeated issue previously documented as known by any of the customer identifiers.

15. A non-transitory computer readable medium having stored thereon instructions comprising executable code which when executed by one or more processors, causes the one or more processors to:
retrieve at least customer service data and customer sales order data from one or more stored customer database systems associated with customer identifiers for a plurality of customers;
execute predictive modeling algorithm on the customer service data and the customer order data to generate one of a plurality of customer confidence rankings for each of the customer identifiers; and
initiate at least one automated action based on the generated customer confidence rankings for the one or more customer identifiers.

16. The non-transitory computer readable medium as set forth in claim 15 wherein the executable code when executed by the one or more processors further causes the one or more processors to:
automated map of one or more customer descriptors with the customer service data and the customer order data in one or more stored systems to the one or more customer identifiers based on specific mapping criteria, wherein the retrieving is further based on the automated mapping.

17. The non-transitory computer readable medium as set forth in claim 15 wherein the customer service data comprises datasets of customer service case records for the customer identifiers and wherein the customer order data comprises at least in-process sales order data, in-preparation sales order data, open sales order data, and pre-sales opportunity data for the plurality of customers.

18. The non-transitory computer readable medium as set in claim 17 wherein the pre-sales opportunity quantities data in the customer order data comprises a determined percentage of successfully completing each of the pre-sales opportunity sales in the pre-sales opportunity data.

19. The non-transitory computer readable medium as set forth in claim 17 wherein for the execute the predictive modeling, the executable code when executed by the one or more processors further causes the one or more processors to further comprises:
execute a binomial distribution algorithm on the customer service records and the customer order data.

20. The non-transitory computer readable medium as set forth in claim 15 wherein the execute the predictive modeling algorithm on the customer service data and the customer order data is over a set period of time, wherein the set period of time is adjustable.

21. The non-transitory computer readable medium as set forth in claim 15 wherein the executable code when executed by the one or more processors further causes the one or more processors to further comprises:
execute a machine learning technique on the predictive modeling algorithm based on one or more control parameters to optimize the generation of one of the plurality of customer confidence rankings for each of the customer identifiers;
wherein the one or more control parameters comprise: a confidence interval time period over which an evaluation is executed; a warranty return rate for one or more of the customer identifiers; a win probability to classify a pre-sales opportunity as part of the n orders in process; one or more adjustments to what is summed into n for the in-process sales order data, the in-preparation sales order data, the open sales order data, or the pre-sales opportunity data for the customer identifiers; warranty data on a number of warranty returns; natural language processing and assessment of customer textual input in one of a plurality of assessment categories; or prior issue data on any repeated issue previously documented as known by any of the customer identifiers.
